(19) United States
(12) Patent Application Publication
(10) Pub. No.: US 2018/0057974 A1
(43) Pub. Date: Mar. 1, 2018

(54) HOLLOW FIBER MEMBRANE MANUFACTURING METHOD

(71) Applicant: TORAY INDUSTRIES, INC., Tokyo (JP)

(72) Inventors: Kenta IWAI, Shiga (JP); Toshiyuki ISHIZAKI, Shiga (JP)

(73) Assignee: TORAY INDUSTRIES, INC., Tokyo (JP)

(21) Appl. No.: 15/563,333

(22) PCT Filed: Mar. 31, 2016
(86) PCT No.: PCT/JP2016/060812

§ 371 Date: Sep. 29, 2017

(30) Foreign Application Priority Data
Mar. 31, 2015 (JP) 2015-072325

(51) Int. Cl. D02J 1/22; B01D 69/08; B01D 61/14; D01D 5/24; D01F 6/12

(52) U.S. Cl. CPC D02J 1/22; B01D 69/08; B01D 61/145; D10B 2505/04; D01D 5/24; D01F 6/12; B01D 61/147

(57) ABSTRACT

An object of the present invention is to provide a stretching method for producing a membrane of narrowed hollow fibers while suppressing hollow fiber crushing (flattening), using a simple stretching process. The present invention relates to a method for manufacturing a hollow fiber membrane that performs narrowing of diameter of a hollow fiber by stretching, that is, includes a step of narrowing diameter of a hollow fiber by stretching the hollow fiber that has been subjected to a spinning step, using rolls each of which is formed with a groove.

### TECHNICAL FIELD

The present invention relates to a method for manufacturing a hollow fiber membrane, which is employed in the fields of ultrafiltration and microfiltration for solid-liquid separation such as clarification.

### BACKGROUND ART

In recent years, in the field of water purification such as clarification and sterilization of river water, underground water, etc. and clarification of industrial water, microfiltration or ultrafiltration hollow fiber membranes which are superior in resistance to chemicals, mechanical strength, water permeability, etc. have been used to accommodate physical cleaning and chemical cleaning of membrane recovery technology.

Patent Document 1 discloses stretching a hollow fiber membrane to reform it.

Patent Document 1 discloses, as a conventional stretching method, a roll stretching method in which stretching is performed between plural stretching drive rolls that are different in circumferential speed. In the roll stretching method, fiber slipping due to insufficient friction is suppressed by setting the angle of contact at which a hollow fiber is wound on each drive roll to transmit drive force of each roll to the hollow fiber through friction (adhesion).

However, a hollow fiber may be flattened (deformed in external shape) receiving bending stress (compressive force) at its curved surface that is in contact with a roll. When a hollow fiber membrane is used for outside-in filtration, its flattening may result in characteristic degradations such as reduction in pressure resistance and increase in the flow resistance of permeate. In a case where a coat layer is formed by coating in which hollow fibers stretched by the roll stretching method serve as a support layer, the flattening of a hollow fiber membrane may cause structural defects such as coating spots because of imperfect formation of the coat layer.

As a technique for suppressing such flattening of a hollow fiber occurring at its roll-contact curved surface, Patent Document 1 discloses a belt-type method in which a hollow fiber is stretched being sandwiched between elastic body belts facing each other.

### BACKGROUND ART DOCUMENT

### Patent Document

Patent Document 1: Japanese Patent No. 3,928,927

### SUMMARY OF THE INVENTION

### Problems that the Invention is to Solve

However, even with the technique of Patent Document 1, since a hollow fiber is stretched being sandwiched between the top and bottom elastic belts facing each other, the hollow fiber may be crushed, thereby being flattened.

In view of the above, an object of the present invention is to provide a stretching method for producing a membrane of narrowed hollow fibers while suppressing hollow fiber crushing (flattening), using a simple stretching process.

### Means for Solving the Problems

In order to achieve the above-described object, the present invention provides the following method for manufacturing a hollow fiber membrane and stretching machine.
(1) A method for manufacturing a hollow fiber membrane, the method including:

a spinning step of forming a hollow fiber; and

a stretching step of stretching the hollow fiber using stretching rolls each of which has a groove extending in a circumferential direction of the stretching roll,

in which, in the groove of each of the stretching rolls, wall surfaces thereof facing each other come into contact with the hollow fiber.
(2) The method for manufacturing a hollow fiber membrane according to (1), in which a distance between the wall surfaces of the groove is larger than an outer diameter of the hollow fiber at an outermost portion in a radial direction of the stretching roll and smaller than the outer diameter of the hollow fiber at an innermost portion in the radial direction.
(3) The method for manufacturing a hollow fiber membrane according to (1) or (2), in which, in the groove, the wall surfaces facing each other form an angle that is larger than or equal to 5° and smaller than or equal to 90°.
(4) The method for manufacturing a hollow fiber membrane according to any one of (1) to (3), in which surfaces of the groove of each of the stretching rolls are subjected to satin processing.
(5) The method for manufacturing a hollow fiber membrane according to any one of (1) to (4), in which each of the stretching rolls has a rubber elastic material at least in surfaces of the groove.
(6) A stretching machine which is installed in a conveyance path of a hollow fiber and which includes a send-out-side stretching roll and a pull-out-side stretching roll each of which has a groove extending in a circumferential direction of the stretching roll,

in which the send-out-side stretching roll and the pull-out-side stretching roll are disposed so that, in the groove of each of the stretching rolls, wall surfaces thereof facing each other come into contact with the hollow fiber.

### Advantage of the Invention

The present invention makes it possible to produce a membrane of high-circularity, narrowed hollow fibers by stretching which suppresses flattening of a hollow fiber.

### BRIEF DESCRIPTION OF THE DRAWINGS

FIG. 1 is a front view showing one example of a stretching roll used in an embodiment of the present invention.

FIGS. 2(a) and 2(b) are schematic sectional views of respective stretching rolls.

FIG. 3 is a schematic flow diagram illustrating one example of a stretching step according to the present invention.

### MODE FOR CARRYING OUT THE INVENTION

### [Method for Manufacturing Hollow Fiber Membrane]

The present invention provides a method for manufacturing a hollow fiber membrane, including a spinning step and a stretching step. The above individual steps will be described below in detail.

### 1. Spinning Step

The spinning step for forming a hollow fiber is not limited to any specific method, and may be any of various steps capable of producing a hollow fiber that can be used for a separation membrane after being subjected to the stretching step (described later). For example, conventional spinning methods that are used for manufacture of a hollow fiber membrane are used preferably. Among such spinning methods are solution spinning and melt spinning. The solution spinning is a method for producing a fiber by producing a raw liquid by melting a raw material in a solvent and discharging the raw liquid from a spinneret. The solution spinning includes dry spinning and wet spinning. The melt spinning is a method for producing a fiber by discharging a heat-melted raw material from a spinneret and solidifying it through cooling.

As resin materials for a hollow fiber, thermoplastic resins including a chain polymer may be used, and examples thereof include polyethylene, polypropylene, an acrylic resin, polyacrylonitrile, an acrylonitrile-butadiene-styrene (ABS) resin, a vinyl chloride resin, polyethylene terephthalate, polyamide, polyacetal, polycarbonate, modified polyphenylene ether, polyphenylene sulfide, polyvinylidene fluoride, polyamideimide, polyetherimide, polysulfone, polyethersulfone, and mixtures and copolymers thereof. Among these examples, use of a polyvinylidene fluoride-based resin which is high in resistance to chemicals and mechanical strength is preferable.

The term “polyvinylidene fluoride-based resin” means a resin that contains a vinylidene fluoride homopolymer and/or a vinylidene fluoride copolymer, and may contain plural kinds of vinylidene fluoride copolymers. The polyvinylidene fluoride-based resin is a polymer having a vinylidene fluoride residue structure, and is typically a copolymer of a vinylidene fluoride monomer and another monomer such as a fluorine-containing monomer.

Examples of such a copolymer include a copolymer of vinylidene fluoride with one or more compounds selected from vinylidene fluoride, ethylene tetrafluoride, propylene hexafluoride and ethylene trifluoride chloride. A monomer other than a fluorine-containing monomer, such as ethylene, may be copolymerized therewith as long as the advantages of the present invention are not impaired.

Examples of a solvent that can be used with a polyvinylidene fluoride-based resin include good solvents such as N-methyl-2-pyrrolidon, dimethyl sulfoxide, dimethylacetamide, dimethylfolmamide, methyl ethyl ketone, acetone, tetrahydrofuran, tetramethylurea, and trimethyl phosphate and poor solvents such as cyclohexane, isophorone, γ-butyrolactone, methyl isoamyl ketone, dimethyl phthalate, propylene glycol methyl ether, propylene carbonate, diacetone alcohol, and glycerol triacetate.

A hollow fiber membrane can be formed with a non-solvent phase separation method, a thermally induced phase separation method, or the like by producing a membrane formation raw liquid by melting these materials in a solvent and discharging it from a spinneret into a coagulation bath.

### 2. Stretching Step

In this step, spun hollow fibers are stretched by stretching rolls each of which has a groove extending in a circumferential direction of the stretching roll.

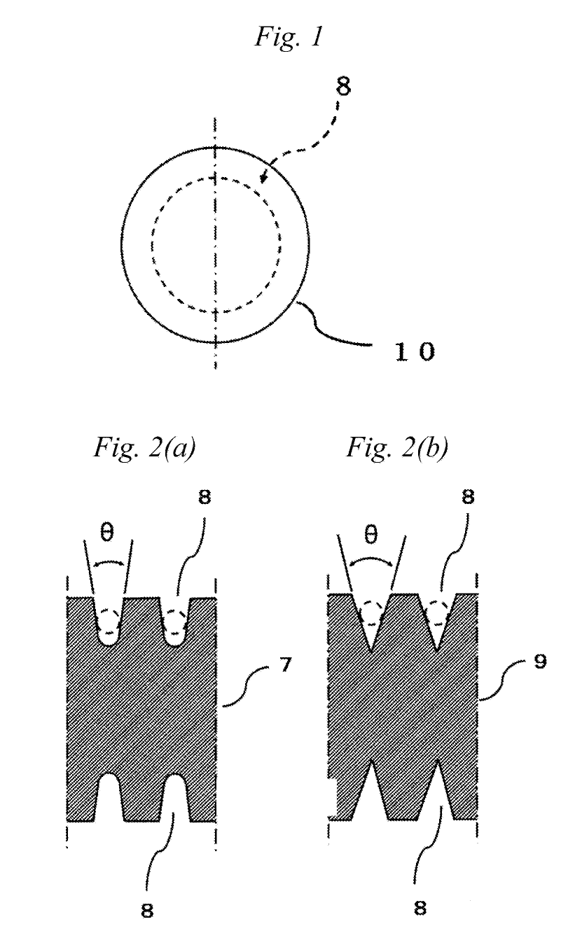

FIG. 1 is a front view of an example of the stretching roll. FIG. 2(a) is a schematic sectional view, taken along a chain line in FIG. 1, of the stretching roll. FIG. 2(b) is a schematic sectional view of a stretching roll having another form.

In the stretching roll 10 (stretching rolls 7 and 9), the surface that is located outside in the radial direction has grooves 8 each of which is continuous in the circumferential direction. Wall surfaces are formed so as to face each other and gaps between them are grooves. The stretching roll 10 may have the structure of either of the stretching rolls 7 and 9.

In the stretching rolls 7 and 9, the wall surfaces (side surfaces) of each groove are in contact with a hollow fiber. Positions of hollow fibers are indicated by broken lines. By stretching hollow fibers with the rolls having these structures, the hollow fibers can be stretched without being flattened.

More specifically, the distance between the wall surfaces of each groove (groove width) converges, that is, decreases as the position goes inward in the radial direction. At an outermost portion (opening portion), in the radial direction, of the stretching roll, the distance between the wall surfaces of each groove is longer than the outer diameter of the hollow fiber. At an innermost portion (the bottom surface), the distance between the wall surfaces of each groove is shorter than the outer diameter of the hollow fiber. As a result, the stretching roll, more specifically, both wall surface portions between the outermost portion and the innermost portion, can come into contact with a hollow fiber. Particularly in the present embodiment, the distance between the wall surfaces increases monotonously as the position goes outward in the radial direction.

A hollow fiber spun in the spinning step is not completely uniform, and its shape and outer diameter vary over time to no small extent. A non-recessed roll comes into contact with a hollow fiber at only one point. Thus, in order to obtain friction (adhesion) that is necessary for stretching, it is necessary to wind a hollow fiber around the roll. As a result, when a compressive force acts on the hollow fiber during stretching, the force is concentrated at the one support point to render the fiber prone to be crushed.

On the other hand, in the case of the stretching roll according to the present embodiment, both wall surfaces of each groove come into contact with a hollow fiber and hence the stretching roll comes into contact with the hollow fiber at two points. Thus, a compressive force to act on the hollow fiber can be distributed so as to act on it via the two support points. Furthermore, even if the contact positions of a fiber move (its outer diameter varies), the speed of the outer circumference of the fiber varies in such a direction as to balance the fiber tension. As a result, the angle of contact to the hollow fiber can be reduced. Sufficient friction can be obtained even if the fiber follows a straight locus. Furthermore, since friction can be obtained in this manner, the fiber can be stretched without using another member for pressing it from above the stretching roller even if the fiber follows a straight locus.

It is preferable that the confrontation angle θ formed by the wall surfaces facing each other in each groove is larger than or equal to 5° and smaller than or equal to 90°, and it is more preferable that the confrontation angle θ is larger than or equal to 5° and smaller than or equal to 80°. This is because the gripping force of the support points being in contact with a hollow fiber is kept strong in these ranges. The confrontation angle θ is an angle that is formed by the straight portions of the two wall surfaces.

In a case where the plural stretching rolls are arranged on one line, it is preferable that the plural stretching rolls are different from each other in the distance between the wall surfaces (groove width) or the confrontation angle θ. With this measure, a position at which a hollow fiber is in contact with one stretching roll can be made different from a position at which the hollow fiber is in contact with another stretching roll. As a result, the hollow fiber receives forces from the respective stretching rolls at distributed contact portions, whereby the hollow fiber can be stretched without being flattened.

There are no particular limitations on the groove shape; it suffices that as described above each groove is shaped so that a hollow fiber comes into contact with the wall surfaces facing each other in the groove. The opening width and the depth of each groove should be in a range of 1.5 to 20 times the outer diameter of a hollow fiber.

As for specific examples of the shape of the grooves, the stretching roll 7 shown in FIG. 2(a) has grooves each of which extends in the circumferential direction and has a V-shaped cross section with a round bottom. And the stretching roll 7 shown in FIG. 2(b) has grooves each of which extends in the circumferential direction and has a V-shaped cross section.

A material of the stretching rolls can be selected as appropriate from, for example, a metal material, a ceramic material, a plastic material, a rubber material (rubber elastic material), etc. Among these materials, the rubber elastic material is preferable because its elastic polymer material is deformed by tensile stress that occurs during stretching, whereby the area of contact with a hollow fiber is increased, resulting in increase in adhesion (friction). Since the rubber elastic material provides the advantage that the area of contact with a hollow fiber is increased to intensify the adhesion (friction), it suffices that the rubber elastic material is provided at least in the surfaces, in particular, portions to come into contact with a fiber, of each groove of each stretching roll.

It is preferable that the rubber elastic material is one having static elastic shear modulus, which is one index of elastic moduli, of larger than or equal to 0.05 MPa and smaller than or equal to 0.6 MPa. The rubber elastic material that is in this elastic modulus range is preferable because by virtue of its elastic deformation the degree of deformation of a hollow fiber being in contact with it is made low. Among various kinds of rubber elastic materials, because of high resistance to a solvent contained in a hollow fiber, it is preferable to use a rubber elastic resin such as a silicone rubber, a urethane rubber, an isoprene rubber, a styrene-butadiene rubber, a butadiene rubber, an ethylene-propylene rubber, or a polysulfide rubber. By measuring a 25% elongational stress σ₂₅ (MPa) according to JIS K 6254-5 “small deformation tensile test,” a static elastic shear modulus Gₛ is calculated according to the following equation:

Gₛ=1.639σ₂₅(MPa).

It is preferable that the wall surfaces of each groove of each stretching roll are subjected to surface treatment in order to increase the contact resistance with a hollow fiber. For example, in the case of a high-hardness metal material, it is preferable to increase its surface roughness; and as one example of such a processing method, satin processing is preferable.

The satin processing is performed by blasting roll surfaces with abrasive grains such as aluminum oxide grains, dry silica sand, or glass beads (blowing the latter over the former). It is preferable that each stretching roll surface (the groove wall surface) is treated so that the roughness index Ra (10-point arithmetic average roughness) becomes larger than or equal to 2 μm and smaller than or equal to 300 μm, and the roughness index Rz (maximum height) becomes larger than or equal to 3 μm and smaller than or equal to 400 μm.

Carrying out the above treatment is preferable because microscopic projections on the groove surfaces of each roll come into direct contact with the surface of a hollow fiber and suppress reduction in adhesion even if the surface of the hollow fiber that has been subjected to the spinning step is wet with a solvent. Values of the surface roughness indices Ra and Rz (JIS B 0601-2001) can be obtained, for example, from roughness curves measured by a stylus surface roughness tester.

The combination of the above-described shape of the grooves of each stretching roll, material of the stretching rolls, and surface structure obtained by the surface treatment may be any combination instead of a particular combination.

For example, the stretching roll 7 shown in FIG. 2(a) is made of a metal and formed with the grooves each of which extends in the circumferential direction and has a V-shaped cross section with a round bottom. And its groove surfaces are surfaces that were subjected to satin processing. The stretching roll 9 shown in FIG. 2(b) is a rubber roll and is formed with the grooves each of which extends in the circumferential direction and has a V-shaped cross section.

A region where hollow fibers are stretched during a manufacturing process is called a stretching zone.

### [Stretching Machine]

The present invention also provides a stretching machine that can be used for the above-described stretching step. The stretching machine according to the present invention is installed in a conveyance path of hollow fibers and includes send-out-side stretching rolls and pull-out-side stretching rolls. The send-out-side stretching rolls and the pull-out-side stretching rolls are disposed so that, in the groove of each of the stretching rolls, wall surfaces thereof facing each other come into contact with a hollow fiber.

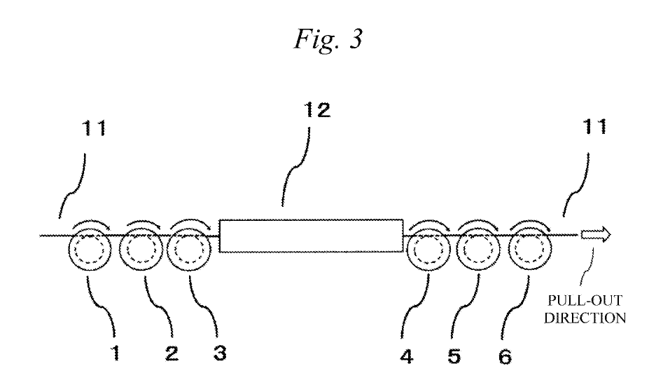

FIG. 3 shows an example of the stretching machine. In the present embodiment, the send-out-side stretching rolls 1, 2, and 3 and the pull-out-side stretching rolls 4, 5, and 6 each of which has the grooves extending in the circumferential direction are disposed in the conveyance path of hollow fibers 11. The send-out-side stretching rolls 1, 2, and 3 and the pull-out-side stretching rolls 4, 5, and 6 are disposed so that, in the groove of each of the stretching rolls, wall surfaces thereof facing each other come into contact with a hollow fiber. Although not shown in the figure, the stretching machine according to the present embodiment is equipped with a send-out-side drive device for rotating the send-out-side stretching rolls 1, 2, and 3 and a pull-out-side drive device for rotating the pull-out-side stretching rolls 4, 5, and 6 so that the rotation speed of the pull-out-side stretching rolls 4, 5, and 6 becomes higher than that of the send-out-side stretching rolls 1, 2, and 3.

As shown in FIG. 3, a stretching zone 12 is disposed between the send-out-side stretching rolls and the pull-out-side stretching rolls. More specifically, the send-out-side stretching rolls 1, 2, and 3, the stretching zone 12, and the pull-out-side stretching rolls 4, 5, and 6 are arranged in series in this order on a straight line in such a manner that the stretching zone 12 is interposed between the send-out-side stretching rolls 1, 2, and 3 and the pull-out-side stretching rolls 4, 5, and 6. With this configuration, each hollow fiber 11 is guided so as to follow a straight locus from the most upstream stretching roll 1 to the most downstream stretching roll 6 and not to be wound on any stretching roll. Part, located in the stretching zone 12, of each hollow fiber 11 is stretched due to the difference between linear speeds of the send-out-side stretching rolls 1, 2, and 3 and the pull-out-side stretching rolls 4, 5, and 6. As mentioned above, no member for pressing a hollow fiber to each stretching roll is necessary. The stretching step may be executed in plural stages by providing plural stretching zones.

The expression “follow a straight locus” means that a hollow fiber is in contact with the stretching rolls in a state that it extends straightly. That is, a hollow fiber is not wound on the stretching rolls and extends straightly at the portion where the hollow fiber is in contact with each stretching roll. In other words, the stretching rolls are disposed at positions where each hollow fiber extends straightly. Thus, in a case where plural stretching rolls are arranged in series, they are arranged so that portions to come into contact with each hollow fiber are arranged straightly. An appropriate method for guiding hollow fibers so that they follow straight loci in the above manner is to dispose other rolls upstream of the send-out-side stretching rolls and downstream of the pull-out-side stretching rolls in such a manner that they hold the hollow fibers straightly.

Taking into consideration the fact that hollow fibers 11 are narrowed by the stretching, the outer diameter of each hollow fiber 11 before the stretching is preferably larger than or equal to 0.4 mm and smaller than or equal to 50 mm, and more preferably larger than or equal to 0.5 mm and smaller than or equal to 40 mm. Hollow fibers may have such a size when produced by the spinning step. Alternatively, the outer diameter of each hollow fiber 11 may be adjusted so as to fall within either of these ranges by a step that is executed after the spinning step and before the stretching step. Setting the outer diameter of each hollow fiber 11 in this range is preferable because variation in elongation and narrowing uniformity that is caused by the stretching can be reduced.

The stretching ratio is preferably 1.1 to 5 times, more preferably 1.3 to 4 times, and further preferably 1.5 to 3 times. The stretching ratio means a linear speed ratio ((taken-up speed)/(supply speed)) in the stretching zone.

The arrangement of the stretching rolls can be optimized so that the taken-up tension of each hollow fiber is balanced.

It is preferable that the hollow fibers 11 are heated in the stretching zone 12. It is therefore preferable that the stretching zone 12 is provided in a bath or a chamber that enables moist-heat treatment and dry-heat treatment.

It is preferable that a heating medium for heating hollow fibers in the stretching zone 12 is at least one selected from solutions such as water, polyethylene glycol and glycerin, and gases such as vapor, air and nitrogen.

There are no particular limitations on the stretching temperature; however, processing hollow fibers at a temperature that is higher than or equal to their glass transition temperature is preferable from the viewpoint of plastic processing. In the case of hollow fibers made of a polyvinylidene fluoride-based resin, a preferable stretching temperature range is 60° C. to 140° C., a more preferable range is 70° C. to 120° C., and a further preferable range is 80° C. to 100° C. In a case where hollow fibers are stretched at 60° C. or higher, uniform stretching can be performed easily. In a case where hollow fibers are stretched at 140° C. or lower, softening due to plasticity is suppressed and hence the hollow fibers are made less prone to crush.

### EXAMPLES

Although the present invention will be described using Examples, the invention should not be construed as being restricted by the following description.

### [Measuring Method of Circularity of Hollow Fiber]

A longer-axis diameter and a shorter-axis diameter of the cross section of a hollow fiber were measured at 10 points at arbitrary magnification (20 to 200 times) that enabled observation of the cross section of a hollow fiber using a digital microscope (VHX-1000 produced by Keyence Corporation) and resulting (shorter-axis diameter)/(longer-axis diameter) ratios were number-averaged.

### Example 1>

A vinylidene fluoride homopolymer (36 wt %) having a weight-average molecular weight of 420,000 and γ-butyrolactone (64 wt %) were melted at 140° C. A resulting vinylidene fluoride homopolymer solution was discharged from an outside orifice (outer diameter: 4.0 mm) of a tube-in orifice. At the same time, an aqueous solution of γ-butyrolactone (85 wt %) was spun out from an inside orifice of the tube-in orifice (outer diameter: 1.4 mm; inner diameter 1.0 mm) in hollow fiber form into a cooled bath (temperature: 15° C.) of an aqueous solution of γ-butyrolactone (85 wt %). Hollow fibers thus spun out were washed with water and then stretched using three send-out-side stretching rolls and three pull-out-side stretching rolls.

The send-out-side stretching rolls and the pull-out-side stretching rolls were arranged on a straight line. The hollow fibers were held straightly by a roll that is disposed upstream of the send-out-side stretching rolls and a roll that is disposed downstream of the pull-out-side stretching rolls, and were brought into contact with the stretching rolls on straight locus. The hollow fibers were sent out from the send-out-side stretching rolls at a speed of 5 m/min and, after passage through the stretching zone, pulled out by the pull-out-side stretching rolls at a speed of 11 m/min, whereby the stretching ratio was 2.2.

Both of the send-out-side stretching rolls and the pull-out-side stretching rolls were made of stainless steel and were formed with V-shaped grooves that were 10 mm in depth and had a confrontation angle of 20° and a round bottom. The width (opening width) of each groove at the outermost portion in the circumferential direction was 6.5 mm. Surface roughness indices Ra and Rz of the grooves of each stretching roll were 17 μm and 110 μm, respectively. Surface roughness indices Ra and Rz (JIS B 0601-2001) were determined from roughness curves measured by a stylus surface roughness tester.

The stretching zone was a hot water bath that was kept at 95° C. The hollow fibers had an outer diameter of 1.02 mm and circularity of 96.2% before being put into the stretching zone, and had an outer diameter of 0.59 mm (i.e., narrowed) and circularity of 95.6% after being subjected to the stretching.

### Example 2

Hollow fibers were spun and washed with water in the same manner as in Example 1 except that a tube-in orifice whose diameters (orifice outer diameter: 2.1 mm; tube outer diameter: 0.7 mm; tube inner diameter: 0.5 mm) were different from those in Example 1 was used.

Hollow fibers thus produced were stretched at a stretching ratio of 1.5 by setting the sum of angles of contact of the three send-out-side stretching rolls at 270° and the speed at 7 m/min and setting the sum of angles of contact of the three pull-out-side stretching rolls disposed downstream of the stretching zone also at 270° and the speed at 10.5 m/min. Each stretching roll was a silicone rubber roll that was formed with V-shaped grooves having a depth of 10 mm and a confrontation angle of 35°, and that had a rubber elastic modulus of 0.24 MPa. As the stretching zone, an air heating type hot wind chamber in which the temperature was set at 80° C. was used, thereby performing stretching. A width (opening width) at the outermost portion in the circumferential direction of each stretching roll was 6.2 mm. As in Example, 1, three send-out-side stretching rolls and three pull-out-side stretching rolls were used.

The hollow fibers had an outer diameter of 1.20 mm and circularity of 97.4% before being put into the stretching zone, and had an outer diameter of 0.96 mm (i.e., narrowed) and circularity of 97.0% after being subjected to the stretching.

### Comparative Example 1

Stretching was performed in the same manner as in Example 1 except that the stretching rolls were changed to non-recessed metal rolls. However, hollow fibers slipped at the pull-out-side stretching rolls and could not be stretched in a desired manner.

### Comparative Example 2

Stretching was performed in the same manner as in Example 2 except that the stretching rolls were changed to non-recessed silicone rubber rolls. Hollow fibers had an outer diameter of 1.20 mm and circularity of 96.5% before being put into the stretching zone, and had an outer diameter of 0.91 mm (i.e., narrowed) and circularity of 68.6% (i.e., flattened) after being subjected to the stretching.

It was found from the above results that hollow fibers that were high in circularity were produced successfully in Examples which used the stretching rolls in which the wall surfaces facing each other in each groove came into contact with a hollow fiber. On the other hand, in Comparative Examples that used the non-recessed stretching rolls, produced hollow fibers were low in circularity, that is, were flattened.

Although the present invention has been described in detail using the particular modes, it is apparent to those skilled in the art that various changes and modifications are possible without departing from the spirit and scope of the present invention. The present application is based on Japanese Patent Application No. 2015-072325 filed on Mar. 31, 2015, the whole of which is incorporated by reference.

### INDUSTRIAL APPLICABILITY

The present invention can provide a method for manufacturing a membrane of high-circularity, narrowed hollow fibers by a simple stretching method. As a result, the present invention can provide high-quality, composite hollow fiber membranes that can be applied to a water treatment field for treatment of purified water, industrial water, etc.

### DESCRIPTION OF REFERENCE NUMERALS AND SIGNS

1, 2, 3, 4, 5, 6, 10: Stretching roll

7: Metal roll (stretching roll) having V-shaped grooves with a round bottom

8: Groove

9: Rubber roll (stretching roll) having V-shaped grooves

11: Hollow fiber

12: Stretching zone

1-6. (canceled)

7. A method for manufacturing a hollow fiber membrane, the method comprising:
a spinning step of forming a hollow fiber; and
a stretching step of stretching the hollow fiber using stretching rolls each of which has a groove extending in a circumferential direction of the stretching roll,
wherein, in the groove of each of the stretching rolls, wall surfaces thereof facing each other come into contact with the hollow fiber.

8. The method for manufacturing a hollow fiber membrane according to claim 7, wherein a distance between the wall surfaces of the groove is larger than an outer diameter of the hollow fiber at an outermost portion in a radial direction of the stretching roll and smaller than the outer diameter of the hollow fiber at an innermost portion in the radial direction.

9. The method for manufacturing a hollow fiber membrane according to claim 7, wherein, in the groove, the wall surfaces facing each other form an angle that is larger than or equal to 5° and smaller than or equal to 90°.

10. The method for manufacturing a hollow fiber membrane according to claim 8, wherein, in the groove, the wall surfaces facing each other form an angle that is larger than or equal to 5° and smaller than or equal to 90°.

11. The method for manufacturing a hollow fiber membrane according to claim 7, wherein surfaces of the groove of each of the stretching rolls are subjected to satin processing.

12. The method for manufacturing a hollow fiber membrane according to claim 7, wherein each of the stretching rolls has a rubber elastic material at least in surfaces of the groove.

13. A stretching machine which is installed in a conveyance path of a hollow fiber and which comprises a send-out-side stretching roll and a pull-out-side stretching roll each of which has a groove extending in a circumferential direction of the stretching roll,
wherein the send-out-side stretching roll and the pull-out-side stretching roll are disposed so that, in the groove of each of the stretching rolls, wall surfaces thereof facing each other come into contact with the hollow fiber.

14. The stretching machine according to claim 13, wherein a distance between the wall surfaces of the groove is larger than an outer diameter of the hollow fiber at an outermost portion in a radial direction of each of the stretching roll and smaller than the outer diameter of the hollow fiber at an innermost portion in the radial direction.

15. The stretching machine according to claim 13, wherein, in the groove, the wall surfaces facing each other form an angle that is larger than or equal to 5° and smaller than or equal to 90°.

16. The stretching machine according to claim 14, wherein, in the groove, the wall surfaces facing each other form an angle that is larger than or equal to 5° and smaller than or equal to 90°.
